(19) United States
(12) Patent Application Publication
(10) Pub. No.: US 2026/0320497 A1
(43) Pub. Date: Oct. 15, 2026

(54) METHOD FOR EFFICIENT MACHINE LEARNING MODEL PERSONALIZATION

(71) Applicant: SAMSUNG ELECTRONICS CO., LTD., Suwon-si (KR)

(72) Inventors: Da LI, Chertsey (GB); Timothy HOSPEDALES, Chertsey (GB); Jijoong MOON, Suwon-si (KR)

(73) Assignee: SAMSUNG ELECTRONICS CO., LTD., Suwon-si (KR)

(21) Appl. No.: 19/692,499

(22) Filed: May 29, 2026

Related U.S. Application Data
(63) Continuation of application No. PCT/KR2024/005212, filed on Apr. 18, 2024.

(30) Foreign Application Priority Data
Nov. 29, 2023 (GB) 2318256.1

(51) Int. Cl. G06N 20/00

(52) U.S. Cl. CPC G06N 20/00

(57) ABSTRACT

A method using a pair of user devices formed of a teacher user device and a student user device where the student device uses the ML model for a task is provided. A method performed by the teacher device may include receiving, from the student device of the pair of user devices, at least one captured data item and a request for a student machine learning model to be updated, where the student ML model is stored on the student device and is to be used by the student device. The method may include updating, using the received at least one captured data item, a subset of a plurality of parameters of a copy of the student machine learning model that is stored on the teacher device. The method may include transmitting the updated subset of parameters to the student device for updating the student ML model.

### CROSS-REFERENCE TO RELATED APPLICATIONS

This application is a continuation of International Application No. PCT/KR2024/005212, filed on Apr. 18, 2024, which is based on and claims priority to United Kingdom Patent Application No. 2318256.1, filed on Nov. 29, 2023, in the United Kingdom Intellectual Property Office, the disclosures of which are incorporated by reference herein in their entireties.

### BACKGROUND

### 1. Field

The present disclosure relates to a computer-implemented method for personalizing machine learning, ML, models used by resource-constrained user devices. In particular, the embodiment of the disclosure relate to a computer-implemented method for personalization of a machine learning, ML, model using a pair of user devices formed of a teacher user device and a student user device, where the student user device uses the ML model for a task.

### 2. Description of Related Art

On-device personalization is a technique used to adapt a pre-trained AI or ML model to a user's environment to improve model performance. However, typically, on-device personalization relies on sufficient computing capability of the user's device and is largely ineffective when the capability is very limited. Furthermore, on-device personalization is difficult because quantization—to reduce the overall size of the model—is difficult to do on resource-constrained devices. When user devices are resource-constrained edge devices, on-device personalization is particularly difficult.

Teacher-student knowledge distillation is a popular approach aimed at improving a smaller student model using knowledge provided from a larger teacher model. The knowledge encompasses either feature representations or model predictions by the teacher model. However, teacher-student training is conventionally carried out on centralized cloud computing facilities.

The applicant has therefore identified the need for a technique for performing on-device personalization using teacher-student knowledge distillation and without needing model re-quantization.

### SUMMARY

According to an embodiment of the disclosure, a computer-implemented method for personalization of a machine learning model using a pair of user devices formed of a teacher user device and a student user device where the student user device uses the ML model for a task is provided. According to an embodiment of the disclosure, a computer-implemented method performed by the teacher user device may include receiving, from the student user device of the pair of user devices, at least one captured data item and a request for a student machine learning model to be updated, where the student ML model is stored on the student user device and is to be used by the student user device. According to an embodiment of the disclosure, a computer-implemented method performed by the teacher user device may include updating, using the received at least one captured data item, a subset of a plurality of parameters of a copy of the student machine learning model that is stored on the teacher user device. According to an embodiment of the disclosure, a computer-implemented method performed by the teacher user device may include transmitting the updated subset of parameters to the student user device for updating the student ML model.

According to an embodiment of the disclosure, a teacher user device for personalization of a machine learning model using a pair of user devices formed of the teacher user device and a student user device where the student user device uses the ML model for a task is provide. According to an embodiment of the disclosure, the teacher user device may include storage for storing a copy of a student machine learning model used by the student user device and at least one processor coupled to memory. According to an embodiment of the disclosure, the at least one processor coupled to memory may be configured to receive, from the student user device of the pair of user devices, at least one captured data item and a request for a student machine learning model to be updated, where the student ML model is stored on the student user device and is to be used by the student user device. According to an embodiment of the disclosure, the at least one processor coupled to memory may be configured to update, using the received at least one captured data item, a subset of a plurality of parameters of a copy of the student machine learning model that is stored on the teacher user device. According to an embodiment of the disclosure, the at least one processor coupled to memory may be configured to transmit the updated subset of parameters to the student user device for updating the student ML model.

According to an embodiment of the disclosure, a computer-implemented method for personalization of a machine learning model using a pair of user devices formed of a teacher user device and a student user device where the student user device uses the ML model for a task is provided. According to an embodiment of the disclosure, a computer-implemented method performed by the student user device may include transmitting, to the teacher user device of the pair of user devices, at least one captured data item and a request for a student machine learning model which is to be used by the student user device to be updated. According to an embodiment of the disclosure, a computer-implemented method performed by the student user device may include receiving, from the teacher user device, at least one updated parameter of the student ML model, the at least one updated parameter having been determined by the teacher user device. According to an embodiment of the disclosure, a computer-implemented method performed by the student user device may include updating, using the received at least one updated parameter, the student ML model on the student user device.

According to an embodiment of the disclosure, a student user device for personalization of a machine learning model using a pair of user devices formed of a teacher user device and the student user device where the student user device uses the ML model for a task is provided. According to an embodiment of the disclosure, the student user device may include storage for storing a copy of a student machine learning model used by the student user device and at least one processor coupled to memory. According to an embodiment of the disclosure, the at least one processor coupled to memory may be configured to transmit, to the teacher user device of the pair of user devices, at least one captured data item and a request for a student machine learning, ML, model used by the student user device to be updated. According to an embodiment of the disclosure, the at least one processor coupled to memory may be configured to receive, from the teacher user device, at least one updated parameter of the student ML model, the at least one updated parameter having been determined by the teacher user device. According to an embodiment of the disclosure, the at least one processor coupled to memory may be configured to update, using the received at least one updated parameter, the student ML model.

According to an embodiment of the disclosure, a system for personalization of a machine learning model using at least one pair of user devices, each pair being formed of a teacher user device and a student user device is provided. According to an embodiment of the disclosure, a system may include at least one student user device and a teacher user device paired to the at least one student user device. According to an embodiment of the disclosure, the at least one student user device may include storage for storing a student machine learning model which is to be used by the student user device and at least one processor coupled to memory. According to an embodiment of the disclosure, the at least one processor coupled to memory may be configured to transmit, to the teacher user device, at least one captured data item and a request for a student machine learning model used by the student user device to be updated. According to an embodiment of the disclosure, the at least one processor coupled to memory may be configured to receive, from the teacher user device, at least one updated parameter of the student ML model, the at least one updated parameter having been determined by the teacher user device. According to an embodiment of the disclosure, the at least one processor coupled to memory may be configured to update, using the received at least one updated parameter, the student ML model. According to an embodiment of the disclosure, a teacher user device may include storage for storing a copy of a student machine learning model used by the at least one student user device. According to an embodiment of the disclosure, the at least one processor coupled to memory may be configured to receive, from the at least one student user device, at least one captured data item and a request for the copy of the student ML model to be updated. According to an embodiment of the disclosure, the at least one processor coupled to memory may be configured to update, using the received at least one captured data item, a subset of a plurality of parameters of the student machine learning model which is to be used by the student user device from which the at least one captured data item was received. According to an embodiment of the disclosure, the at least one processor coupled to memory may be configured to transmit, to the student user device from which the at least one captured data item was received, the updated at least one parameter for updating the student ML model.

### BRIEF DESCRIPTION OF THE DRAWINGS

Implementations of the embodiment of the disclosure will now be described, by way of example only, with reference to the accompanying drawings, in which:

FIG. 1 is a schematic diagram showing an existing technique for training, quantizing and deploying a model on a deployment device;

FIG. 2 is a schematic diagram illustrating the embodiment of the disclosure;

FIG. 3 is a flowchart of example steps performed by a student user device;

FIG. 4 is a flowchart of example steps performed by a teacher user device;

FIG. 5 is a schematic diagram showing the embodiment of the disclosure for deploying a quantized model with updatable modules;

FIG. 6 is a schematic diagram showing the embodiment of the disclosure for performing among-device model updates;

FIG. 7 is a schematic diagram of a system for personalization of a quantized machine learning, ML, model on a deployment device with a paired teacher user device;

FIG. 8 shows a flowchart of example steps performed by a cloud server to generate a model to be deployed on student user devices;

FIG. 9 is a flowchart of example steps performed by a student user device to capture data items;

FIG. 10 is a flowchart of example steps performed by a teacher user device to update the copy of the student ML model;

FIG. 11 is a schematic diagram of an example student ML model architecture; and

FIG. 12 is a table of experimental results from evaluating the performance of the present personalization technique.

### DETAILED DESCRIPTION

Embodiments of the present disclosure will be described in detail below. Embodiments have been illustrated in the accompanying drawings, in which the same or similar reference numerals refer to the same or similar elements, or elements having the same or similar functions. The embodiments described with reference to the accompanying drawings are illustrative, used only to explain the present disclosure, and should not be construed as limiting it in any way.

Reference will now be made to the various embodiments and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the disclosure. Furthermore, in terms of the construction of the device, one or more components of the device may have been represented in the drawings by conventional symbols, and the drawings may show only those specific details that are pertinent to understanding the embodiments so as not to obscure the drawings with details that will be readily apparent to those of ordinary skill in the art having the benefit of the description herein.

It will be understood by those skilled in the art that the foregoing general description and the following detailed description are explanatory of the disclosure and are not intended to be restrictive thereof.

Reference throughout this specification to “an aspect,” “another aspect” or similar language means that a particular feature, structure, or characteristic described in connection with the embodiment is included in at least one embodiment of the disclosure. Thus, appearances of the phrase “in an embodiment”, “in another embodiment” and similar language throughout this specification may, but do not necessarily, all refer to the same embodiment.

The terms “comprises”, “comprising”, “includes”, “including”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Before undertaking the detailed description below, it may be advantageous to set forth definitions of certain words and phrases used throughout the present disclosure. The term “couple” and the derivatives thereof refer to any direct or indirect communication between two or more elements, whether or not those elements are in physical contact with each other. The terms “transmit”, “receive”, and “communicate” as well as the derivatives thereof encompass both direct and indirect communication. The terms “include” and “comprise”, and the derivatives thereof refer to inclusion without limitation. The term “or” is an inclusive term meaning “and/or”. The phrase “associated with,” as well as derivatives thereof, refer to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” refers to any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of A, B, and C” includes any of the following combinations: A, B, C, A and B, A and C, B and C, and A and B and C, and any variations thereof. Similarly, the term “set” means one or more. Accordingly, the set of items may be a single item or a collection of two or more items.

The processor may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as Read Only Memory (ROM), Random Access Memory (RAM), a hard disk drive, a Compact Disc (CD), a Digital Video Disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

In a first approach of the embodiment of the disclosure, there is provided a computer-implemented method for personalization of a machine learning, ML, model using a pair of user devices formed of a teacher user device and a student user device where the student user device uses the ML model for a task, the method performed by the teacher user device comprising: receiving, from the student user device of the pair of user devices, at least one captured data item and a request for a student machine learning, ML, model to be updated, where the student ML model is stored on the student user device and is to be used by the student user device; updating, using the received at least one captured data item, a subset of a plurality of parameters of a copy of the student machine learning, ML, model that is stored on the teacher user device; and transmitting the updated subset of parameters to the student user device for updating the student ML model.

Advantageously, the embodiment of the disclosure enable an ML model that is used by a resource-constrained student user device to be personalized without the student user device needing to communicate with a server which originally trained the ML model and in particular, without needing to send any data items captured by the student user device to the server. As the student user device is resource-constrained, it does not have the hardware capability to personalize the ML model itself on-device or to support to re-quantize the personalized student model. However, not personalizing the ML model would lead to poor performance when the ML model is used for a specific user. Thus, advantageously, the embodiment of the disclosure pair the student user device with another user device-referred to as a teacher user device-which has more resources for updating the ML model used by the student user device. The teacher user device and student user device are both owned or used by the same user, which means that data privacy is preserved because data items captured by the student user device are not shared with any third party. The teacher user device stores a shared copy of the ML model used by the student user device, and updates the copy using data items received from the student user device. Updated parameters of the copy of the ML model are sent to the student user device for incorporation through placeholder into the ML model stored on the student user device.

In an embodiment, the at least one captured data item may be labelled. The embodiment may be the case if a user of the student user device (who is also the user of the teacher user device) provides a label for the data item. In such cases, it is straightforward for the teacher user device to update the copy of the student ML model stored on the teacher user device, because a ground truth for the data item is already known.

In an embodiment, the at least one captured data item may be unlabeled. In the embodiment, the teacher user device needs to try to obtain a label for the data item(s) before updating the copy of the student ML model stored on the teacher user device. Thus, the method may further comprise: inputting the at least one captured unlabeled data item into a teacher machine learning, ML, model stored at the teacher user device; and outputting, from the teacher ML model, a pseudo-label for the at least one captured unlabeled data item. For example, the teacher user device stores a teacher ML model which corresponds to the copy of the student ML model. Teacher-student knowledge distillation involves two models-a teacher ML model and a student ML model, where the two models correspond to each other and are for the same task, and where the teacher ML model is larger/stronger than the student ML model and is therefore able to make predictions with more accuracy than the student ML model. The student ML model is useful for execution on resource-constrained devices. As explained in more detail below, the student user device typically provides captured data items to the teacher user device for which it is unable to provide accurate predictions. The teacher user device uses the teacher ML model to obtain a pseudo-label for each captured data item, which is likely to be more accurate than the prediction made by the student user device. The pseudo-label can then be used by the teacher user device to train/update the copy of the student ML model.

The updating may comprise: inputting the at least one captured unlabeled data item into the copy of the student ML model stored on the teacher user device; outputting, from the copy of the student model, a prediction for the at least one captured unlabeled data item; determining a knowledge distillation loss using the pseudo-label output by the teacher ML model for the at least one captured unlabeled data item and the prediction of the student ML model for the at least one captured unlabeled data item; and updating the subset of the plurality of parameters of the student ML model to thereby minimize the knowledge distillation loss. In this way, knowledge from the teacher ML model is transferred to the student ML model.

The updating may comprise: updating a subset of the plurality of parameters of the student ML model which are updateable parameters, wherein a remainder of the plurality of parameters are non-updateable frozen and quantized parameters. As mentioned above, the student ML model may be small compared to the teacher ML model and any corresponding ML model stored on a central server, so that the ML model can be easily executed by the student user device which is resource-constrained. The size of the student ML model may be achieved by quantization. Quantization is used to reduce model size, though it can sometimes result in reduced accuracy. There are two types of quantization: post-training quantization and quantization-aware training. Quantization-aware training is a training technique that enables an ML model to update during training with simulated quantization effects, performed during training of the model. Post-training quantization is a technique employed to quantize a model after training.

ML models may use different floating-point number formats, such as 32-bit and 16-bit floats (FP32 and FP16 respectively), and even 8-bit floating point formats (FP8). Quantization reduces model size by converting model weights from high-precision floating-point representation to low-precision floating-point (FP) or integer (INT) representations, such as 16-bit or 8-bit. The quantization can reduce the model size as well the processing power and memory required during inference without severely negatively impacting accuracy. The term “INT8” is often used to mean an ML model is quantized into an 8-bit integer representation.

In the embodiment of the disclosure, to avoid having to re-quantize the student ML model every time it is updated by the teacher ML model, the student ML model comprises updateable parameters and non-updatable frozen parameters. Importantly, the updateable parameters are set as placeholders, whose values can be flexibly assigned after initialization, such that updating the student model is possible without model re-quantization. When the student ML model is created at a server for deployment on user devices, the student ML model is divided into two parts—the non-updateable frozen parameters and a small number of updatable (e.g., placeholder) parameters. The non-updateable frozen parameters are quantized when deployed on the student user devices, to ensure the size of the student ML model is suitable for the student user devices. The server also chooses a suitable precision format for the updateable (e.g., placeholder) parameters. The updatable (e.g., placeholder) parameters may be integers or floating point numbers. When the teacher user device trains/updates the copy of the student ML model, it does so in a quantization-aware manner. For example, the integer or floating point values of the updatable parameters are updated in a quantization-aware manner, in which there is a simulated quantization effect applied on the training model according to the deployed quantized student model.

The subset of the plurality of parameters (e.g. the placeholder parameters) of the copy of the student ML model which are updated/updateable are parameters of a specific module or modules of the model. Parameter-efficient Fine-tuning (PEFT) is a technique used in machine learning to improve the performance of pre-trained models on specific downstream tasks. PEFT may involve reusing the pre-trained model's parameters and fine-tuning the parameters on a smaller dataset, which saves computational resources and time compared to training the entire model from scratch. PEFT may improve the performance of pre-trained model by freezing some of the layers of the pre-trained model and either only fine-tuning the last few layers that are specific to the downstream task or fine-tuning a set of weight biases, affine parameters of Batch norm layers or any adapter modules, etc. The model can be adapted to new tasks with less computational overhead and fewer labelled samples. The model is particularly useful when personalizing a pre-trained model for a specific user device because the user device may be resource-constrained and the user device only has some data items available for the personalization.

In an embodiment, the updating performed by the teacher user device may comprise: updating, using the received at least one captured data item, at least one parameter of a parameter-efficient fine-tuning, PEFT, module of the student ML model. The PEFT module of the student ML model may be adaptable. In an embodiment, if only one type of PEFT module can be used in/with the student ML model, the updating comprises updating that PEFT module.

Alternatively, the updating performed by the teacher user device may comprise: updating, using the received at least one captured data item, at least one parameter of a plurality of parameter-efficient fine-tuning, PEFT, modules of the student ML model stored on the teacher user device; selecting a PEFT module from the plurality of PEFT modules based on at least one selection criterion; and wherein transmitting the updated subset of parameters comprises transmitting the updated at least one parameter of the selected PEFT module to the student user device for updating the student ML model. For example, when any one of multiple PEFT modules can be used in/with the student ML model, the updating comprises updating all of the PEFT modules on the teacher ML model and then selecting the updated PEFT module that provides the best performance to the student ML model.

Preferably selecting a PEFT module based on at least one selection criterion may comprise using any one or more of the following selection criterion: the entropy of the predictions of the at least one captured data item using different PEFT modules; and a clustering quality based on predictions made for a plurality of captured data items. An example way to select the best PEFT module is described in Ericsson, Linus, Li, Da and Hospedales, Timothy M, “Better Practices for Domain Adaptation”, AutoML, 2023.

In a second approach of the embodiment of the disclosure, there is provided a teacher user device for personalization of a machine learning, ML, model using a pair of user devices formed of the teacher user device and a student user device where the student user device uses the ML model for a task, the teacher user device comprising: storage for storing a copy of a student machine learning, ML, model used by the student user device; and at least one processor coupled to memory, for: receiving, from the student user device of the pair of user devices, at least one captured data item and a request for a student machine learning, ML, model to be updated, where the student ML model is stored on the student user device and is to be used by the student user device; updating, using the received at least one captured data item, a subset of a plurality of parameters of a copy of the student machine learning, ML, model for example stored on the teacher user device; and transmitting the updated subset of parameters to the student user device for updating the student ML model.

The features described above with respect to the first approach apply equally to the second approach and therefore, for the sake of conciseness are not repeated.

The storage may also store a teacher ML model for updating the copy of the student ML model using knowledge distillation when the at least one received captured data item is unlabeled, as described above.

In a third approach of the embodiment of the disclosure, there is provided a computer-implemented method for personalization of a machine learning, ML, model using a pair of user devices formed of a teacher user device and a student user device where the student user device uses the ML model for a task, the method performed by the student user device comprising: transmitting, to the teacher user device of the pair of user devices, at least one captured data item and a request for a student machine learning, ML, model which is to be used by the student user device to be updated; receiving, from the teacher user device, at least one updated parameter of the student ML model, the at least one updated parameter having been determined by the teacher user device; and updating, using the received at least one updated parameter, the student ML model on the student user device.

Thus, when the student user device requires the student ML model to be updated, the student user device transmits at least one captured data item to the teacher user device together with a request for the student ML model to be updated. The transmitting may be prompted by the student ML model not being able to output a prediction for the at least one captured data item with a required accuracy. The student ML model may typically be unable to make predictions with a required accuracy when the student ML model encounters a data item that the student ML model has not been trained on when originally trained by a server. For example, if the student ML model was trained by a server using a training dataset containing images of furniture, but the student user device is being used in a user's home containing an unusual piece of furniture, the student ML model may not be able to accurately recognize the user's piece of furniture.

The method performed by the student user device may further comprise: capturing the at least one captured data item using a sensor of the student user device. The captured data item may be any data item suitable for processing using the student ML model and which is appropriate for the task performed by the student ML model.

The method performed by the student user device may further comprise: inputting the at least one captured data item into the student ML model for processing and generating a processing result; determining a level of confidence of the processing result of the student ML model; and transmitting the at least one captured data item and a request for the student ML model to be updated when the determined level of confidence is lower than a threshold confidence level. Thus, low accuracy or low confidence level predictions/processing results may trigger the need for the student ML model to be updated.

Updating the student ML model by the student user device may comprise replacing at least one updatable (placeholder) parameter of the student ML model with the received at least one updated parameter received from the teacher user device. Thus, the student user device may simply swap the input value of the placeholder of the at least one updatable parameter in the student ML model with the value of the received updated at least one parameter.

The method may further comprise: transmitting, to the teacher user device, the student ML model when sending a first request for an update to the student ML model. Thus, the first time the student user device needs the student ML model to be updated, the student user device also sends a copy of the student ML model to the teacher user device for storage and use. The teacher user device may obtain a corresponding teacher ML model from a server, as explained below with respect to the Figures.

The method may further comprise: transmitting, to the teacher user device, at least one captured data item for storing on the teacher user device. Since the student user device is resource-constrained, the student user device may not have much memory/storage for storing captured data items. Thus, the student user device may transmit captured data items to the teacher user device for storage. The transmitting may be useful because it enables captured data items to be available on the teacher user device before the student user device requests the student ML model to be updated. The transmitting may also be beneficial to the teacher user device, and the user of the teacher user device. For example, when a user pairs a student user device (e.g. a vacuum cleaner) with a teacher user device (e.g. a smartphone), the user may wish to continue using their teacher user device (e.g. to make calls or watch a video) when the teacher user device is also trying to update the copy of the student ML model. As updating the model will consume a lot of the hardware resources of the teacher user device, performance of the teacher user device for other tasks that the user wants to perform (e.g. making a call) may be adversely affected. Thus, it can be beneficial for the student user device to transmit captured data items whenever they are captured, so that the teacher user device has the data needed to perform the update in advance, and so that the teacher user device is ready to perform the update at a suitable time when the user experience will not be impacted (e.g. when the user is asleep).

In a fourth approach of the embodiment of the disclosure, there is provided a student user device for personalization of a machine learning, ML, model using a pair of user devices formed of a teacher user device and the student user device where the student user device uses the ML model for a task, the student user device comprising: storage for storing a student machine learning, ML, model which is to be used by the student user device; and at least one processor coupled to memory, for: transmitting, to the teacher user device of the pair of user devices, at least one captured data item and a request for a student machine learning, ML, model used by the student user device to be updated; receiving, from the teacher user device, at least one updated parameter of the student ML model, the at least one updated parameter having been determined by the teacher user device; and updating, using the received at least one updated parameter, the student ML model.

The features described above with respect to the third approach apply equally to the fourth approach and therefore, for the sake of conciseness are not repeated.

The student user device may further comprise a sensor for capturing the at least one captured data item. The sensor may be any type of sensor, such as a camera, microphone, temperature sensor, and so on.

In an embodiment, the sensor may be a camera, and the at least one captured data item may be an image or a frame of a video.

The student user device may be a constrained-resource device, but which has the minimum hardware capabilities to use a trained neural network/ML model. The student user device may be any one of: a smartphone, tablet, laptop, computer or computing device, virtual assistant device, a vehicle, an autonomous vehicle, a robot or robotic device, a robotic assistant, image capture system or device, an augmented reality system or device, a virtual reality system or device, a gaming system, an Internet of Things device, or a smart consumer device (such as a smart fridge or vacuum cleaner). It will be understood that this is a non-exhaustive and non-limiting list of example client devices.

In an embodiment, the student user device may be a smart autonomous robotic vacuum cleaner, for example, which is able to automatically move around an environment. The vacuum cleaner may comprise at least one camera to capture images of the environment so that the vacuum cleaner can move around the environment without bumping into objects or vacuuming objects that should not be vacuumed (such as pets, or cups placed on the floor).

The student ML model may be an object detection model.

In a fifth approach of the embodiment of the disclosure, there is provided a system for personalization of a machine learning, ML, model using at least one pair of user devices, each pair being formed of a teacher user device and a student user device, the system comprising: at least one student user device; and a teacher user device paired to the at least one student user device; wherein the at least one student user device comprises: storage for storing a student machine learning, ML, model which is to be used by the student user device; and at least one processor coupled to memory, for: transmitting, to the teacher user device, at least one captured data item and a request for a student machine learning, ML, model used by the student user device to be updated; receiving, from the teacher user device, at least one updated parameter of the student ML model, the at least one updated parameter having been determined by the teacher user device; and updating, using the received at least one updated parameter, the student ML model; and wherein the teacher user device comprises: storage for storing a copy of a student machine learning, ML, model used by the at least one student user device; and at least one processor coupled to memory, for: receiving, from the at least one student user device, at least one captured data item and a request for the copy of the student ML model to be updated; updating, using the received at least one captured data item, a subset of a plurality of parameters of the student machine learning, ML, model which is to be used by the student user device from which the at least one captured data item was received; and transmitting, to the student user device from which the at least one captured data item was received, the updated at least one parameter for updating the student ML model.

The features described above with respect to the first to fourth approaches apply equally to the fifth approach and therefore, for the sake of conciseness are not repeated.

Preferably, the teacher user device and the at least one student user device are operable in the same wireless local area network, WLAN, as each other. Thus, the teacher user device and the or each student user device are in the same environment as each other and may preferably be owned or used by the same user.

The storage of the teacher user device may store a teacher ML model for updating the student ML model using knowledge distillation when the captured data item is unlabeled, as described above.

When the teacher user device is paired to two or more student user devices, the student ML models of the two or more student user devices may be the same, and the teacher user device may use the same teacher ML model for updating the student ML models of each student user device.

Alternatively, when the teacher user device is paired to two or more student user devices, the student ML models of the two or more student user devices may be different, and the teacher user device may use a different corresponding teacher ML model for updating the student ML models of each student user device.

As will be appreciated by one skilled in the art, the embodiment of the disclosure may be embodied as a system, method or computer program product. Accordingly, embodiment of the disclosure may take the form of an entirely hardware embodiment, an entirely software embodiment, or an embodiment combining software and hardware aspects.

Furthermore, the embodiment of the disclosure may take the form of a computer program product embodied in a computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the embodiment of the disclosure may be written in any combination of one or more programming languages, including object-oriented programming languages and conventional procedural programming languages. Code components may be embodied as procedures, methods or the like, and may comprise sub-components which may take the form of instructions or sequences of instructions at any of the levels of abstraction, from the direct machine instructions of a native instruction set to high-level compiled or interpreted language constructs.

Embodiments of the embodiment of the disclosure also provide a non-transitory data carrier carrying code which, when implemented on a processor, causes the processor to carry out any of the methods described herein.

The techniques further provide processor control code to implement the above-described methods, for example on a general purpose computer system or on a digital signal processor (DSP). The techniques also provide a carrier carrying processor control code to, when running, implement any of the above methods, in particular on a non-transitory data carrier. The code may be provided on a carrier such as a disk, a microprocessor, CD- or DVD-ROM, programmed memory such as non-volatile memory (e.g. Flash) or read-only memory (firmware), or on a data carrier such as an optical or electrical signal carrier. Code (and/or data) to implement embodiments of the techniques described herein may comprise source, object or executable code in a conventional programming language (interpreted or compiled) such as Python, C, or assembly code, code for setting up or controlling an ASIC (Application Specific Integrated Circuit) or FPGA (Field Programmable Gate Array), or code for a hardware description language such as Verilog (RTM) or VHDL (Very high speed integrated circuit Hardware Description Language). As the skilled person will appreciate, such code and/or data may be distributed between a plurality of coupled components in communication with one another. The techniques may comprise a controller which includes a microprocessor, working memory and program memory coupled to one or more of the components of the system.

It will also be clear to one of skill in the art that all or part of a logical method according to embodiments of the embodiment of the disclosure may suitably be embodied in a logic apparatus comprising logic elements to perform the steps of the above-described methods, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

In an embodiment, the embodiment of the disclosure may be realized in the form of a data carrier having functional data thereon, said functional data comprising functional computer data structures to, when loaded into a computer system or network and operated upon thereby, enable said computer system to perform all the steps of the above-described method.

The method described above may be wholly or partly performed on an apparatus, e.g. an electronic device, using a machine learning or artificial intelligence model. The model may be processed by an artificial intelligence-dedicated processor designed in a hardware structure specified for artificial intelligence model processing. The artificial intelligence model may be obtained by training. Here, “obtained by training” means that a predefined operation rule or artificial intelligence model configured to perform a desired feature (or purpose) is obtained by training a basic artificial intelligence model with multiple pieces of training data by a training algorithm. The artificial intelligence model may include a plurality of neural network layers. Each of the plurality of neural network layers includes a plurality of weight values and performs neural network computation by computation between a result of computation by a previous layer and the plurality of weight values.

As mentioned above, the embodiment of the disclosure may be implemented using an AI model. A function associated with AI may be performed through the non-volatile memory, the volatile memory, and the processor. The processor may include one or a plurality of processors. At this time, one or a plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The one or a plurality of processors control the processing of the input data in accordance with a predefined operating rule or artificial intelligence (AI) model stored in the non-volatile memory and the volatile memory. The predefined operating rule or artificial intelligence model is provided through training or learning. Here, being provided through learning means that, by applying a learning algorithm to a plurality of learning data, a predefined operating rule or AI model of a desired characteristic is made. The learning may be performed in a device itself in which AI according to an embodiment is performed, and/o may be implemented through a separate server/system.

The AI model may consist of a plurality of neural network layers. Each layer has a plurality of weight values, and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning algorithm is a method for training a predetermined target device (for example, a robot) using a plurality of learning data to cause, allow, or control the target device to make a determination or prediction. Examples of learning algorithms include, but are not limited to, supervised learning, unsupervised learning, semi-supervised learning, or reinforcement learning.

Broadly speaking, the embodiment of the disclosure provide methods for personalizing machine learning, ML, models used by resource-constrained user devices. In particular, the embodiment of the disclosure relate to a computer-implemented method for personalization of a machine learning, ML, model using a pair of user devices formed of a teacher user device and a student user device, where the student user device uses the ML model for a task.

There are a number of challenges of on-device personalization. Users do not want to label captured data items as it is a boring or laborious task. So, personalization must be unsupervised. When the target device is very resource constrained (e.g. smart vacuum), it may be too weak to run a sufficiently strong learning/personalization algorithm for effective personalization. In practice, AI models running on embedded devices like are required to be quantized (compressed) for efficient execution on NPU. However, even if a strong personalized model can be trained on device, it is hard to re-quantize the personalized model for execution without using mainstream cloud compute infrastructure.

The embodiment of the disclosure advantageously compensate the computing limitation of a low-resource target device (e.g., vacuum cleaner) via pairing it with a medium-resource partner device (e.g. smartphone). The target device runs a small and quantized model, and the partner device runs a larger/stronger model that teaches (personalizes) the model from the target device to perform better. Some benefits of the embodiment of the disclosure include: lower requirement of the computing capability of a deployed device for running personalized system; compute efficient personalization; no annotation required for user personalization. As explained in more detail below, the embodiment of the disclosure provide a parameter-efficient module which can be updated without requiring re-quantization and can be optimally selected per student user device.

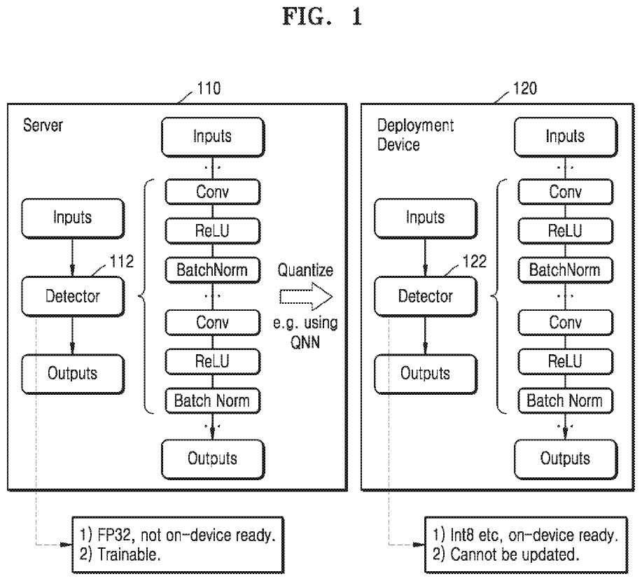

FIG. 1 is a schematic diagram showing an related art for training a model on a server 110, quantizing and deploying it on a device 120. Here, a deployment device 120 is a user device which deploys a quantized ML model, and a server trains a ML model. The deployment device 120 may be considered a compute-limited edge device, and the server 110 may be considered a powerful, non-compute-limited device. The server 110 may have a detector 112 which is trainable but which is not suitable for running on resource-constrained devices like the deployment device. For example, the detector 112 may have a 32-bit floating point precision, which means the overall size of the trained ML model is too large for execution and use by deployment devices 120. In contrast, the student ML model may only be able to run a detector 122 with 8-bit integer precision, which means the overall size is suitable for the deployment device 120, but the detector 122 cannot be updated on the deployment device 120 itself. Therefore, if the deployment device 120 wants to update the deployed model, the model needs to be sent to the server 110. Due to the difference in precision, every time a ML model is updated by the server 110, the updated ML model needs to be quantized before it is sent back to the deployment device for use as the updated deployment ML model. This makes model personalization for a deployed device difficult.

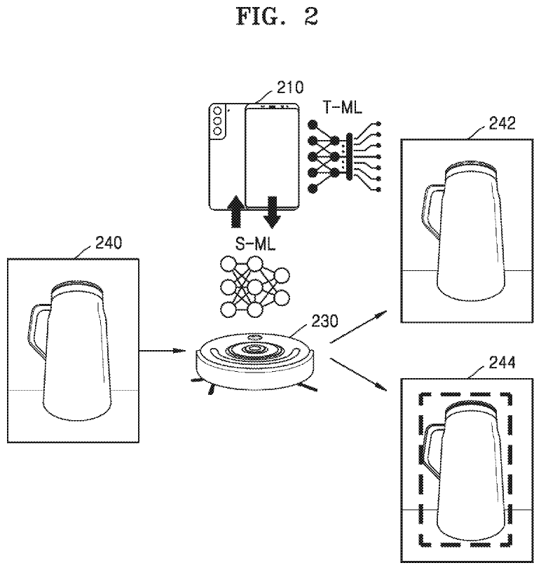

FIG. 2 is a schematic diagram illustrating the embodiment of the disclosure. Here, a student user device 230 has a student ML model S-ML for use when performing a specific task. In the example, the student ML model may be used to perform object recognition/detection in images. An input image 240 is input into the student ML model and the model outputs a prediction 242 identifying each object in the input image. As shown in FIG. 2, the input image depicts a number of objects, but the student ML model has not identified any of these objects.

The embodiment of the disclosure enable a computing-limited device (e.g. student user device 230) to personalize to a user's environment via pairing with a computing-capable device (e.g. teacher user device 210). The computing-capable device may be a smartphone. For example, the student ML model may be an object detection model in an autonomous robotic vacuum cleaner 230. The student ML model may make lots of errors because users' houses look different to the reference images used to train the model. This is why, as shown in FIG. 2, the student ML model's prediction 242 has failed to identify any of the objects in the input image 240. Such errors may lead to wrong behaviors or actions being performed by the student user device 230. Personalization could potentially solve the errors, but it is challenging. This is because there are a number of challenges when personalizing an ML model on a resource-limited device. Firstly, the personalization requires using unlabeled data, which makes personalization harder. Secondly, the limited computing power of the resource-limited device makes it difficult to personalize on the device itself. Thirdly, in cases where the resource-limited device is paired with a teacher device which is less resource-limited, the limited ability of teacher user device means it may not be able to quantize a new model for the student user device even if the teacher device is able to train an improved model. Without the quantization, the resulting updated/improved model may not be executable or even storable on the resource-limited device.

The present personalization techniques lead to a stronger student model that reduces errors, as shown by prediction 244 in which an object has been identified (as indicated by the bounding box around the object). This is achieved by pairing the student user device 230 with a teacher user device 210, which may be a smartphone, for example. The teacher user device 210 is less resource-constrained and therefore can be used to update a copy of the student ML model stored on the teacher user device. As explained in more detail below, the student user device 230 is paired with a teacher user device 210. The teacher user device 210 stores a copy of the student ML model S-ML, and is able to update the copy of the student ML model and send updates back to the student user device 230. The teacher user device 210 may also store a teacher ML model T-ML, whose function is described below.

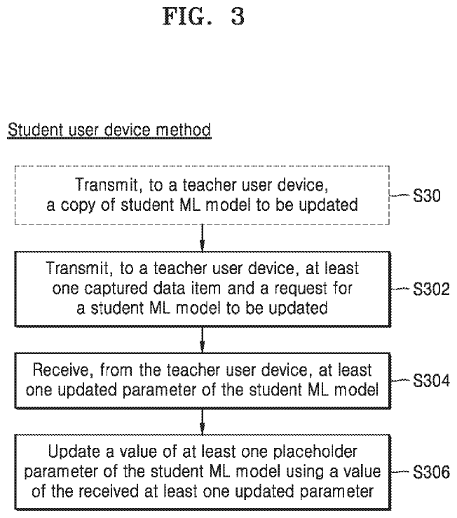

FIG. 3 is a flowchart of example steps performed by a student user device 230. The student user device 230 forms a pair of user devices with a teacher user device 210. The method performed by the student user device 230 comprises: transmitting, to the teacher user device 210 of the pair of user devices, at least one captured data item and a request for a student machine learning, ML, model which is to be used by the student user device 230 to be updated (step S302).

The method comprises: receiving, from the teacher user device 210, at least one updated parameter of the student ML model, the at least one updated parameter having been determined by the teacher user device (step S304).

The method comprises: updating, using the received at least one updated parameter, the student ML model on the student user device 230 (step S306). Updating the student ML model by the student user device may comprise replacing at least one updateable (e.g., placeholder) parameter of the student ML model with the received at least one updated parameter received from the teacher user device. Thus, the student user device may simply swap the input value of the placeholder of the at least one updateable parameter in the student ML model with the value of the received updated at least one parameter. Thus, the updateable placeholder parameters have values that can be replaced/changed, whereas the non-updateable frozen parameters of the student ML model have values that cannot be changed.

Thus, when the student user device 230 requires the student ML model S-ML to be updated, the student user device 230 transmits at least one captured data item to the teacher user device 210 together with a request for the student ML model to be updated. The transmitting may be prompted by the student ML model not being able to output a prediction for the at least one captured data item with a required accuracy. The student ML model may typically be unable to make predictions with a required accuracy when the student ML model encounters a data item that the student ML model has not been trained on when originally trained by a server. For example, if the student ML model was trained by a server using a training dataset containing images of furniture, but the student user device is being used in a user's home containing an unusual piece of furniture, the student ML model may not be able to accurately recognize the user's piece of furniture.

The method performed by the student user device may further comprise: capturing the at least one captured data item using a sensor of the student user device. The captured data item may be any data item suitable for processing using the student ML model and which is appropriate for the task performed by the student ML model.

The method performed by the student user device may further comprise: inputting the at least one captured data item into the student ML model for processing and generating a processing result; determining a level of confidence of the processing result of the student ML model; and transmitting the at least one captured data item and a request for the student ML model to be updated when the determined level of confidence is lower than a threshold confidence level. Thus, low accuracy or low confidence level predictions/processing results may trigger the need for the student ML model to be updated.

The method may further comprise: transmitting, to the teacher user device, the student ML model when sending a first request for an update to the student ML model (step S30). Thus, the first time the student user device needs the student ML model to be updated, the student user device also sends a copy of the student ML model to the teacher user device for storage and use. The teacher user device may obtain a corresponding teacher ML model from a server.

The method may further comprise: transmitting, to the teacher user device, at least one captured data item for storing on the teacher user device. Since the student user device is resource-constrained, the student user device may not have much memory/storage for storing captured data items. Thus, the student user device may transmit captured data items to the teacher user device for storage. The transmitting may be useful because it enables captured data items to be available on the teacher user device before the student user device requests the student ML model to be updated. The transmitting may also be beneficial to the teacher user device, and the user of the teacher user device. For example, when a user pairs a student user device (e.g. a vacuum cleaner) with a teacher user device (e.g. a smartphone), the user may wish to continue using their teacher user device (e.g. to make calls or watch a video) when the teacher user device is also trying to update the copy of the student ML model. As updating the model will consume a lot of the hardware resources of the teacher user device, performance of the teacher user device for other tasks that the user wants to perform (e.g. making a call) may be adversely affected. Thus, it can be beneficial for the student user device to transmit captured data items whenever they are captured, so that the teacher user device has the data needed to perform the update in advance, and so that the teacher user device is ready to perform the update at a suitable time when the user experience will not be impacted (e.g. when the user is asleep).

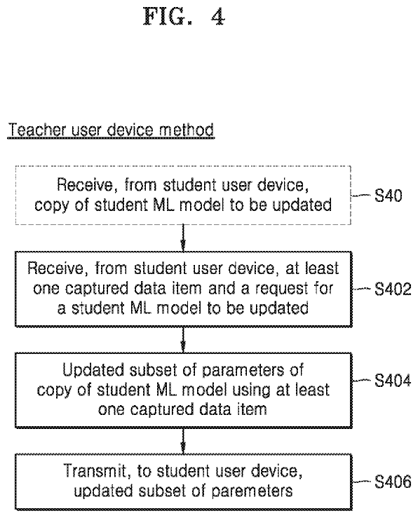

FIG. 4 is a flowchart of example steps performed by a teacher user device 210. The teacher user device 210 forms a pair of user devices with a student user device 230. The method performed by the teacher user device 210 comprises: receiving, from the student user device of the pair of user devices, at least one captured data item and a request for a student machine learning, ML, model to be updated, where the student ML model is stored on the student user device and is to be used by the student user device (step S402).

The method comprises: updating, using the received at least one captured data item, a subset of a plurality of parameters of a copy of the student machine learning, ML, model, that is stored on the teacher user device (step S404).

The method comprises: transmitting the updated subset of parameters to the student user device for updating the student ML model (step S406).

In an embodiment, the at least one captured data item received at step S402 may be labelled. The labelled captured data item may be the case if a user of the student user device (or teacher user device) provides a label for the data item. In such cases, it is straightforward for the teacher user device to update the copy of the student ML model stored on the teacher user device, because a ground truth for the data item is already known.

In an embodiment, the at least one captured data item received at step S402 may be unlabeled. In this case, the teacher user device needs to try to obtain a label for the data item(s) before updating the copy of the student ML model stored on the teacher user device. Thus, the method may further comprise: inputting the at least one captured unlabeled data item into a teacher machine learning, ML, model stored at the teacher user device; and outputting, from the teacher ML model, a pseudo-label for the at least one captured unlabeled data item. For example, the teacher user device stores a teacher ML model T-ML which corresponds to the copy of the student ML model S-ML.

The updating at step S404 may comprise: inputting the at least one captured unlabeled data item into the copy of the student ML model stored on the teacher user device; outputting, from the copy of the student model, a prediction for the at least one captured unlabeled data item; determining a knowledge distillation loss using the pseudo-label output by the teacher ML model for the at least one captured unlabeled data item and the prediction of the student ML model for the at least one captured unlabeled data item; and updating the subset of the plurality of parameters of the student ML model to thereby minimize the knowledge distillation loss. In this way, knowledge from the teacher ML model is transferred to the student ML model.

The updating at step S404 may comprise: updating a subset of the plurality of parameters of the student ML model which are updateable parameters, wherein a remainder of the plurality of parameters are non-updateable frozen and quantized parameters. As mentioned above, the student ML model may be small compared to the teacher ML model and any corresponding ML model stored on a central server, so that the ML model can be easily executed by the student user device which is resource-constrained. The size of the student ML model may be achieved by quantization.

In the embodiment of the disclosure, to avoid having to re-quantize the student ML model every time it is updated by the teacher ML model, the student ML model comprises updateable parameters and non-updatable frozen parameters. When the student ML model is created at a server for deployment on user devices, the student ML model is divided into two parts—the non-updateable frozen parameters and a small number of updatable parameters. Importantly, the updateable parameters are set as placeholders, whose values can be flexibly assigned after initialization, such that updating the student model is possible without model re-quantization. The non-updateable frozen parameters are quantized when deployed on the student user devices, to ensure the size of the student ML model is suitable for the student user devices. The server also chooses a suitable precision format for the placeholders of the updateable parameters. The updatable (e.g., placeholders) parameters may be integers or floating point numbers. When the teacher user device trains/updates the copy of the student ML model, it does so in a quantization-aware manner. For example, the integer or floating point values of the updatable parameters are updated in a quantization-aware manner, in which there is a simulated quantization effect applied on the training model according to the deployed quantized student model.

The subset of the plurality of parameters of the copy of the student ML model which are updated/updateable may include parameters of a specific module or modules of the model. Parameter-efficient Fine-tuning (PEFT) is a technique used in machine learning to improve the performance of pre-trained models on specific downstream tasks. PEFT may involve reusing the pre-trained model's parameters and fine-tuning the parameters on a smaller dataset, which saves computational resources and time compared to training the entire model from scratch. PEFT may improve the performance of pre-trained model by freezing some of the layers of the pre-trained model and either only fine-tuning the last few layers that are specific to the downstream task or fine-tuning a set of weight biases, affine parameters of Batch norm layers or any adapter modules, etc. The model can be adapted to new tasks with less computational overhead and fewer labelled samples. The model is particularly useful when personalizing a pre-trained model for a specific user device because the user device may be resource-constrained and the user device only has some data items available for the personalization.

In an embodiment, the updating performed by the teacher user device at step S404 may comprise: updating, using the received at least one captured data item, at least one parameter of a parameter-efficient fine-tuning, PEFT, module of the student ML model. The PEFT module of the student ML model may be adaptable. In an embodiment, if only one type of PEFT module can be used in/with the student ML model, the updating comprises updating that PEFT module.

Alternatively, the updating performed by the teacher user device at step S404 may comprise: updating, using the received at least one captured data item, at least one parameter of a plurality of parameter-efficient fine-tuning, PEFT, modules of the student ML model stored on the teacher user device; selecting a PEFT module from the plurality of PEFT modules based on at least one selection criterion; and wherein transmitting the updated subset of parameters comprises transmitting the updated at least one parameter of the selected PEFT module to the student user device for updating the student ML model. For example, when any one of multiple PEFT modules can be used in/with the student ML model, the updating comprises updating all of the PEFT modules on the teacher ML model and then selecting the updated PEFT module that provides the best performance to the student ML model.

Preferably selecting a PEFT module based on at least one selection criterion may comprise using any one or more of the following selection criterion: the entropy of the predictions of the at least one captured data item using different PEFT modules; and a clustering quality based on predictions made for a plurality of captured data items. An example way to select the best PEFT module is described in Ericsson, Linus, Li, Da and Hospedales, Timothy M, “Better Practices for Domain Adaptation”, AutoML, 2023. It will be understood that these are just some non-limiting and non-exhaustive examples of how the selecting may be performed.

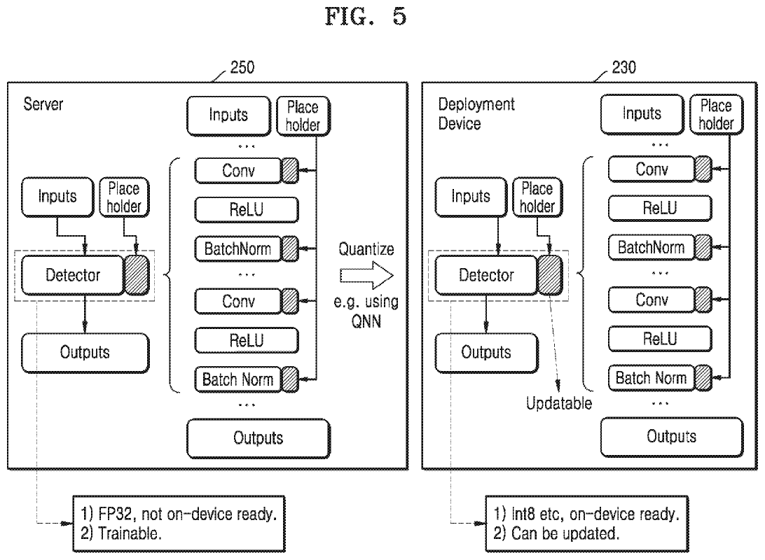

FIG. 5 is a schematic diagram showing the embodiment of the disclosure for deploying a quantized model having updatable modules/parameters. As explained above with reference to FIG. 1, existing on-device personalization only works if and only if the deployed device has enough computing resources and model re-quantization is possible. However, the embodiment of the disclosure make it possible to exploit among-device machine learning to enable personalization, even when the deployment device is too resource-limited to conduct personalization. Furthermore, the embodiment of the disclosure remove the need for model re-quantization.

NPU (Neural Processing Unit) compilation is commonly used for models running on edge devices and refers to the process of optimizing and converting (quantizing) neural network models to run efficiently on NPUs. NPUs are specialized hardware accelerators designed to accelerate deep learning inference tasks, such as those used in AI and machine learning applications. When someone modifies the deployed model's architecture or parameters, an NPU recompilation is required to ensure that this updated model runs efficiently and effectively on the NPU hardware. Sometimes, NPU re-compilation is not possible, so updating a deployed model periodically can be problematic. In the embodiment of the disclosure, quantization of the updated parameters or NPU compilation for model personalization is bypassed by the structure of the student ML model. Essentially, the values of the trainable parameters are treated as some placeholders such that updating the parameter values does not require any NPU recompilation.

As shown in FIG. 5, either the majority of model parameters of the student ML model are frozen so that only a small number of parameters can be updated by the teacher user device, or the whole of the student ML model is frozen and some updatable adapter modules are added to the student ML model, which can be updated by the teacher user device. In both cases, the number of parameters that can be updated is small, meaning the updating performed by the teacher user device can be computationally-efficient. This means the compute capability of the compute-capable device is not required to be extremely high (e.g., as high as a server's ability), and also that the amount of data needed for the updating is limited. Moreover, experimentally, it has been found that with selective designs of the parameter-efficient modules, the present student ML model in which only a subset of parameters is updated can even outperform models in which all parameters are updated.

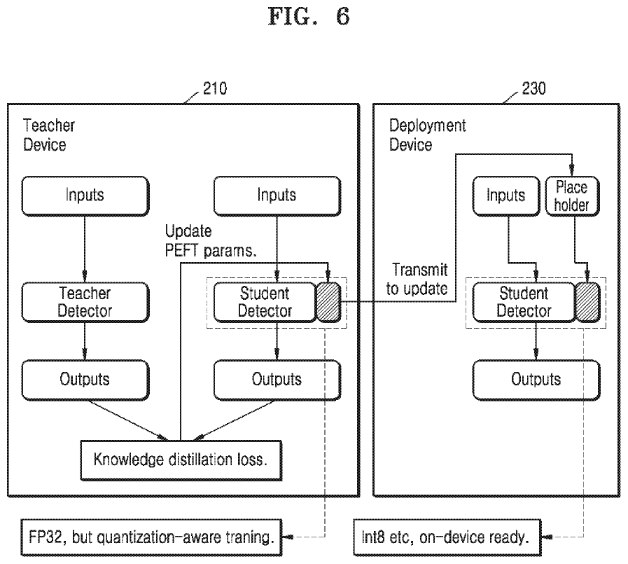

FIG. 6 is a schematic diagram showing the embodiment of the disclosure for performing among-device model updates. The embodiment of the disclosure make use of a pre-trained powerful model in a computing-capable device 210 to guide a weak model from a computing-limited device 230 with unlabeled user data. Although the computing-limited device 230 cannot run a strong model or update even a weak model for the on-device personalization, this limitation can be compensated by its interaction with a computing-capable device 210. The student model can be transported/transmitted to the computing-capable device 210, and a more powerful pre-trained teacher model can guide the training of the weaker student model. Specifically, the student model can adapt to the user's uploaded unlabeled data samples by learning with pseudo-labels from the teacher model.

Personalization without labels normally has poor performance compared to one with labels. However, users do not want to provide labels. In this case, a strong teacher model provides pseudo-labels that are almost as good as user labels.

Importantly, the parameter-efficient modules can be trained and deployed in a way that bypasses the constraint of model quantization. The embodiment of the disclosure decouple the student model into the frozen model parameters and the updatable parameters of (multiple) PEFT modules. Then, the updatable parameters are converted as placeholders, whose values are fed as inputs. In this way, it is not necessary to quantize the trained parameters and conduct NPU recompilation each time after model adaptation. Additionally, it is possible to provide the placeholder for updating a pool of PEFT modules. Furthermore, during the teacher-student model adaptation, the optimal PEFT can be selected for different users as well by some unsupervised model selection criterion.

The embodiment of the disclosure are also advantageous in ecosystems of connected devices that can seamlessly connect and work together. The present among-device teacher-student framework helps bypass the limitation of the computing power of a specific user's edge device by using other connected powerful devices. For instance, a teacher model on a tablet can help a student model on a smartphone, or similarly, a teacher model on a smart TV can advise a student model on a wearable device, etc. This distinguishes the embodiment of the disclosure from existing teacher-student knowledge distillation systems, which runs on the same device.

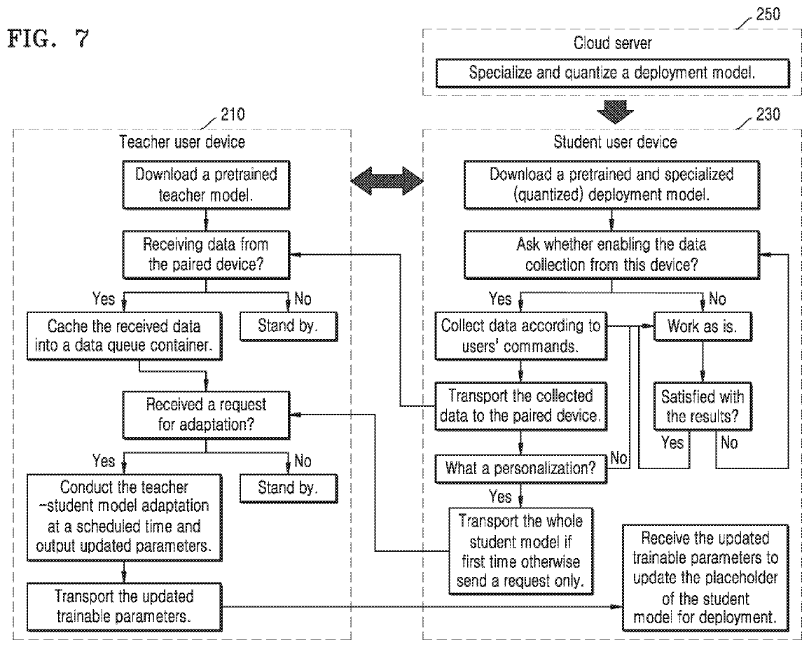

FIG. 7 is a schematic diagram of a system for personalization of a quantized machine learning, ML, model on a deployment device with a paired teacher user device.

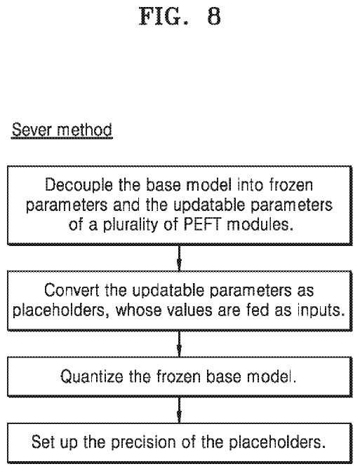

The system comprises a cloud or central sever 250 which generates a model for a specific task that is to be deployed on deployment devices, such as student user device 230. Turning to FIG. 8, this shows a flowchart of example steps performed by a cloud server 250 to generate a model to be deployed on student user devices. The cloud server decouples a base model into two parts-frozen, non-updatable parameters and updateable parameters. The updatable parameters may be provided by one or more PEFT modules. The cloud server may convert the updatable parameters into placeholder modules, and the non-updateable parameters are quantized to reduce the overall size of the model so it is suitable for deployment on constrained-resource student user devices. The cloud server may also specify the precision of the placeholder modules.

Returning to FIG. 7, once the model has been generated, it is provided to a plurality of student user devices 230 for deployment. The student user devices may use the model without it being personalized. Personalization may be required when the student model encounters a data item that the student model cannot provide a prediction for with a required accuracy or certainty.

As shown in FIG. 7, when the student user device requires the student ML model to be updated, the student user device transmits (e.g., transports) at least one captured data item (e.g., collected data) to the teacher user device (e.g., paired device) together with a request for the student ML model to be updated. The transmitting may be prompted by the student ML model not being able to output a prediction for the at least one captured data item with a required accuracy. The student ML model may typically be unable to make predictions with a required accuracy when the student ML model encounters a data item that the student ML model has not been trained on when originally trained by a server.

As shown in FIG. 7, the student user device may input the at least one captured data item into the student ML model for processing and generate a processing result; determine a level of confidence of the processing result of the student ML model; and transmit the at least one captured data item and a request for the student ML model to be updated when the determined level of confidence is lower than a threshold confidence level. Thus, low accuracy or low confidence level predictions/processing results may trigger the need for the student ML model to be updated.

Updating the student ML model by the student user device may comprise replacing at least one updateable (e.g., placeholder) parameter of the student ML model with the received at least one updated parameter received from the teacher user device. Thus, the student user device may simply swap the existing value of the placeholder of the at least one parameter in the student ML model with the value of the received updated at least one parameter.

The student user device may also transmit, to the teacher user device, at least one captured data item for storing on the teacher user device. Since the student user device is resource-constrained, the student user device may not have much memory/storage for storing captured data items. Thus, the student user device may transmit captured data items to the teacher user device for storage.

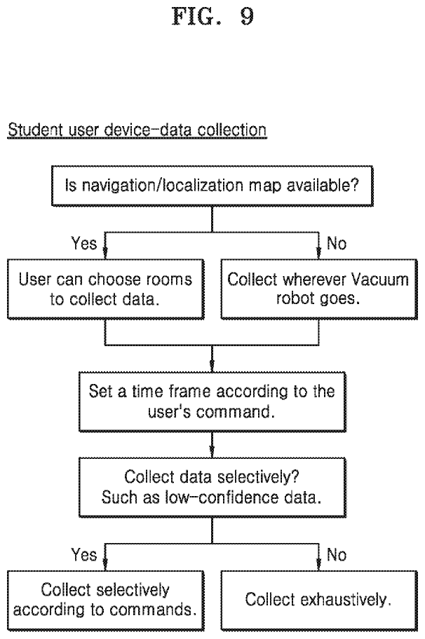

FIG. 9 is a flowchart of example steps performed by a student user device to capture data items. The example steps shown may be implemented by a robotic device such as a vacuum cleaner, but it will be understood that many of these steps may apply to other student user device types. A student user device may capture data items (e.g., such as images) during a specific time frame. During this time frame, the student user device may capture data items selectively (e.g., in response to a specific command to capture data items) or exhaustively. The student user device may transmit the captured data items to the teacher user device periodically or whenever a data item or batch of data items has been captured. The student user device may transmit the captured data items to the teacher user device to enable the student ML model to be updated, or simply for storage (e.g., if the student user device does not send a request for the student ML model to be personalized or updated afterwards or the sent request gets cancelled), as shown in FIG. 7.

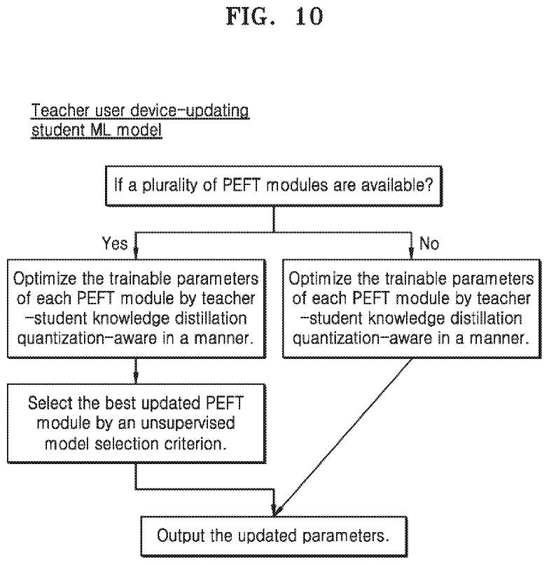

FIG. 10 is a flowchart of example steps performed by a teacher user device to update the copy of the student ML model. The teacher user device may perform the updating at a scheduled time, such as when the teacher user device is not being used for other tasks, to avoid poor user experience of the teacher user device and to ensure the teacher user device has the resources available for the updating. For example, the teacher user device may perform the updating while the teacher user device is not being actively used by a user.

The subset of the plurality of parameters of the copy of the student ML model which are updated/updateable are parameters of a specific module or modules of the model. Parameter-efficient Fine-tuning (PEFT) is a technique used in machine learning to improve the performance of pre-trained models on specific downstream tasks. PEFT may involve reusing the pre-trained model's parameters and fine-tuning the parameters on a smaller dataset, which saves computational resources and time compared to training the entire model from scratch. PEFT may improve the performance of pre-trained model by freezing some of the layers of the pre-trained model and either only fine-tuning the last few layers that are specific to the downstream task or fine-tuning a set of weight biases, affine parameters of Batch norm layers or any adapter modules, etc. The model can be adapted to new tasks with less computational overhead and fewer labelled samples. The model is particularly useful when personalizing a pre-trained model for a specific user device because the user device may be resource-constrained and the user device only has some data items available for the personalization.

In an embodiment (shown on the right hand side of FIG. 10), the updating performed by the teacher user device may comprise: updating, using the received at least one captured data item, at least one parameter of a parameter-efficient fine-tuning, PEFT, module of the student ML model. The PEFT module of the student ML model may be adaptable. In an embodiment, if only one type of PEFT module can be used in/with the student ML model, the updating comprises updating that PEFT module.

Alternatively, as shown on the left hand side of FIG. 10, the updating performed by the teacher user device may comprise: updating, using the received at least one captured data item, at least one parameter of a plurality of parameter-efficient fine-tuning, PEFT, modules of the student ML model stored on the teacher user device; selecting a PEFT module from the plurality of PEFT modules based on at least one selection criterion; and wherein transmitting the updated subset of parameters comprises transmitting the updated at least one parameter of the selected PEFT module to the student user device for updating the student ML model. For example, when any one of multiple PEFT modules can be used in/with the student ML model, the updating comprises updating all of the PEFT modules on the teacher ML model and then selecting the updated PEFT module that provides the best performance to the student ML model.

Preferably selecting a PEFT module based on at least one selection criterion may comprise using any one or more of the following selection criterion: the entropy of the predictions of the at least one captured data item using different PEFT modules; and a clustering quality based on predictions made for a plurality of captured data items. An example way to select the best PEFT module is described in Ericsson, Linus, Li, Da and Hospedales, Timothy M, “Better Practices for Domain Adaptation”, AutoML, 2023.

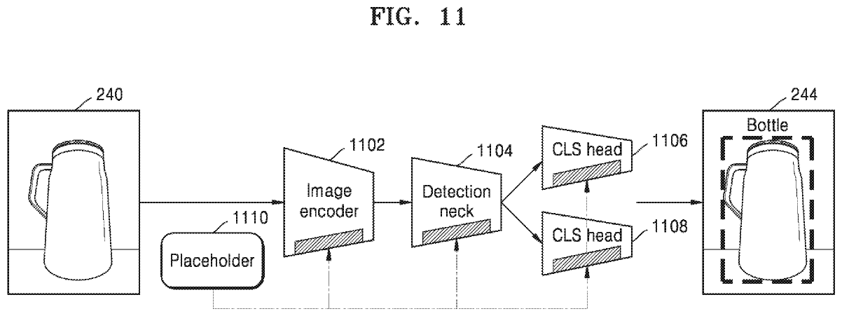

FIG. 11 is a schematic diagram of an example student ML model architecture. In this example, the model is for object detection. The model comprises an image encoder 1102, which takes as input an image 240 from a sensor, and outputs a feature representation of the input image from different layers of the encoder. The model comprises a detection neck 1104, which takes as input the feature representations from the different layers of the encoder, and outputs fused features from different layers. The model comprises a bounding box head 1108, which takes as input the fused features from different layers, and outputs predicted bounding boxes. The model comprises a classification/classifier CLS head 1106, which takes as input the fused features from different layers, and outputs predicted class labels for those bounding boxes. The prediction result 244 of the model shows a bounding box around an object and a class name for the object in the bounding box (“bottle”). Each component of the model (e.g., image encoder, detection neck, etc) comprises a placeholder module 1110. The placeholder modules 1110 comprise updatable parameters, whereas the remainder of each component comprises non-updateable parameters that are quantized. The input into each placeholder module is a normal integer or floating numerical value, and the output is a parameter of the student ML model.

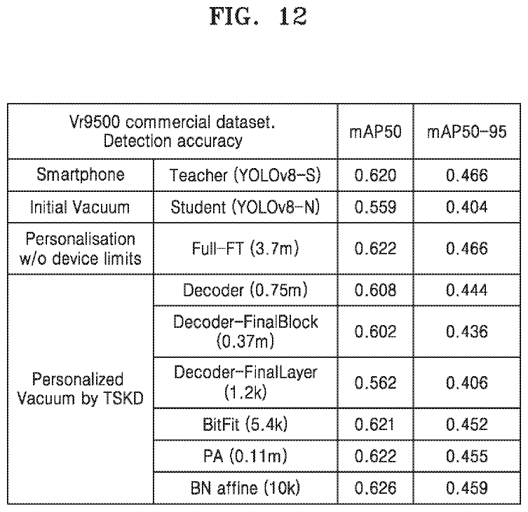

FIG. 12 is a table of results from experiments to evaluate the performance of the present personalization technique, using a Vr9500 image dataset. Mean Average Precision of IoU threshold 0.5 and the average of mean Average Precision over IoU thresholds from 0.5 to 0.95 are reported. It can be seen that the embodiment of the disclosure (fourth to ninth row using different PEFT modules) mostly are comparable to full model adaptation (third row) and all outperform non-adapted model (second row), and that the embodiment of the disclosure are effective for model personalization.

Those skilled in the art will appreciate that while the foregoing has described what is considered to be the best mode and where appropriate other modes of performing embodiment of the disclosure, the embodiment of the disclosure should not be limited to the specific configurations and methods disclosed in this description of the preferred embodiment. Those skilled in the art will recognize that embodiment of the disclosure have a broad range of applications, and that the embodiments may take a wide range of modifications without departing from any inventive concept as defined in the appended claims.

According to an embodiment of the disclosure, the at least one captured data item is unlabeled. According to an embodiment of the disclosure, a computer-implemented method performed by the teacher user device may include inputting the at least one captured unlabeled data item into a teacher machine learning model stored at the teacher user device. According to an embodiment of the disclosure, a computer-implemented method performed by the teacher user device may include outputting, from the teacher ML model, a pseudo-label for the at least one captured unlabeled data item.

According to an embodiment of the disclosure, a computer-implemented method performed by the teacher user device may include inputting the at least one captured unlabeled data item into the copy of the student ML model stored on the teacher user device. According to an embodiment of the disclosure, a computer-implemented method performed by the teacher user device may include outputting, from the copy of the student model, a prediction for the at least one captured unlabeled data item. According to an embodiment of the disclosure, a computer-implemented method performed by the teacher user device may include identifying a knowledge distillation loss using the pseudo-label output by the teacher ML model for the at least one captured unlabeled data item and the prediction of the student ML model for the at least one captured unlabeled data item. According to an embodiment of the disclosure, a computer-implemented method performed by the teacher user device may include updating the subset of the plurality of parameters of the student ML model to thereby minimize the knowledge distillation loss.

According to an embodiment of the disclosure, a computer-implemented method performed by the teacher user device may include updating a subset of the plurality of parameters of the student ML model which are updateable parameters, wherein a remainder of the plurality of parameters are non-updateable frozen and quantized parameters.

According to an embodiment of the disclosure, a computer-implemented method performed by the teacher user device may include updating, using the received at least one captured data item, at least one parameter of a parameter-efficient fine-tuning, PEFT, module of the student ML model.

According to an embodiment of the disclosure, a computer-implemented method performed by the teacher user device may include updating, using the received at least one captured data item, at least one parameter of a plurality of parameter-efficient fine-tuning, PEFT, modules of the student ML model stored on the teacher user device. According to an embodiment of the disclosure, a computer-implemented method performed by the teacher user device may include selecting a PEFT module from the plurality of PEFT modules based on at least one selection criterion. According to an embodiment of the disclosure, a computer-implemented method performed by the teacher user device may include transmitting the updated at least one parameter of the selected PEFT module to the student user device for updating the student ML model.

According to an embodiment of the disclosure, a computer-implemented method performed by the teacher user device may include using any one or more of the following selection criterion: entropy of predictions of the at least one captured data item using different PEFT modules and a clustering quality based on predictions made for multiple captured data items.

According to an embodiment of the disclosure, the storage stores a teacher ML model for updating the copy of the student ML model using knowledge distillation.

According to an embodiment of the disclosure, a computer-implemented method performed by the student user device may include capturing the at least one captured data item using a sensor of the student user device.

According to an embodiment of the disclosure, a computer-implemented method performed by the student user device may include inputting the at least one captured data item into the student ML model for processing and generating a processing result. According to an embodiment of the disclosure, a computer-implemented method performed by the student user device may include identifying a level of confidence of the processing result of the student ML model. According to an embodiment of the disclosure, a computer-implemented method performed by the student user device may include transmitting the at least one captured data item and a request for the student ML model to be updated when the determined level of confidence is lower than a threshold confidence level.

According to an embodiment of the disclosure, a computer-implemented method performed by the student user device may include replacing a value of at least one parameter of the student ML model with a value of the received at least one updated parameter.

According to an embodiment of the disclosure, a computer-implemented method performed by the student user device may include transmitting, to the teacher user device, the student ML model when sending a first request for an update to the student ML model.

According to an embodiment of the disclosure, a computer-implemented method performed by the student user device may include transmitting, to the teacher user device, at least one captured data item for storing on the teacher user device.

According to an embodiment of the disclosure, the student user device may include a sensor for capturing the at least one captured data item.

According to an embodiment of the disclosure, the sensor may be a camera, and the at least one captured data item may be an image or a frame of a video.

According to an embodiment of the disclosure, the student user device may be a vacuum cleaner.

According to an embodiment of the disclosure, the student ML model may be an object detection model.

According to an embodiment of the disclosure, the teacher user device and the at least one student user device may be operable in the same wireless local area network, WLAN, as each other.

According to an embodiment of the disclosure, the storage of the teacher user device stores a teacher ML model for updating the student ML model using knowledge distillation.

According to an embodiment of the disclosure, when the teacher user device is paired to two or more student user devices, the student ML models of the two or more student user devices are the same, and the teacher user device uses the same teacher ML model for updating the student ML models of each student user device.

According to an embodiment of the disclosure, when the teacher user device is paired to two or more student user devices, the student ML models of the two or more student user devices are different, and the teacher user device uses a different corresponding teacher ML model for updating the student ML models of each student user device.

What is claimed is:

1. A computer-implemented method for personalization of a machine learning, ML, model using a pair of user devices formed of a teacher user device and a student user device where the student user device uses the ML model for a task, the method performed by the teacher user device comprising:
receiving, from the student user device of the pair of user devices, at least one captured data item and a request for a student machine learning, ML, model to be updated, where the student ML model is stored on the student user device and is to be used by the student user device;
updating, using the received at least one captured data item, a subset of a plurality of parameters of a copy of the student machine learning, ML, model that is stored on the teacher user device; and
transmitting the updated subset of parameters to the student user device for updating the student ML model.

2. The method as claimed in claim 1, wherein the at least one captured data item is unlabeled, and wherein the method further comprises:
inputting the at least one captured unlabeled data item into a teacher machine learning, ML, model stored at the teacher user device; and
outputting, from the teacher ML model, a pseudo-label for the at least one captured unlabeled data item.

3. The method as claimed in claim 2, wherein the updating comprises:
inputting the at least one captured unlabeled data item into the copy of the student ML model stored on the teacher user device;
outputting, from the copy of the student model, a prediction for the at least one captured unlabeled data item;
identifying a knowledge distillation loss using the pseudo-label output by the teacher ML model for the at least one captured unlabeled data item and the prediction of the student ML model for the at least one captured unlabeled data item; and
updating the subset of the plurality of parameters of the student ML model to thereby minimize the knowledge distillation loss.

4. The method as claimed in claim 1, wherein the updating comprises:
updating a subset of the plurality of parameters of the student ML model which are updateable parameters, wherein a remainder of the plurality of parameters are non-updateable frozen and quantized parameters.

5. The method as claimed in claim 1, wherein the updating comprises:
updating, using the received at least one captured data item, at least one parameter of a parameter-efficient fine-tuning, PEFT, module of the student ML model.

6. The method as claimed in claim 1, wherein the updating comprises:
updating, using the received at least one captured data item, at least one parameter of a plurality of parameter-efficient fine-tuning, PEFT, modules of the student ML model stored on the teacher user device;
selecting a PEFT module from the plurality of PEFT modules based on at least one selection criterion; and
wherein transmitting the updated subset of parameters comprises transmitting the updated at least one parameter of the selected PEFT module to the student user device for updating the student ML model.

7. The method as claimed in claim 6, wherein selecting a PEFT module based on at least one selection criterion comprises using any one or more of the following selection criterion: entropy of predictions of the at least one captured data item using different PEFT modules; and a clustering quality based on predictions made for multiple captured data items.

8. A computer-implemented method for personalization of a machine learning, ML, model using a pair of user devices formed of a teacher user device and a student user device where the student user device uses the ML model for a task, the method performed by the student user device comprising:
transmitting, to the teacher user device of the pair of user devices, at least one captured data item and a request for a student machine learning, ML, model which is to be used by the student user device to be updated;
receiving, from the teacher user device, at least one updated parameter of the student ML model, the at least one updated parameter having been determined by the teacher user device; and
updating, using the received at least one updated parameter, the student ML model on the student user device.

9. The method as claimed in claim 8, the method further comprising:
capturing the at least one captured data item using a sensor of the student user device.

10. The method as claimed in claim 9, the method further comprising:
inputting the at least one captured data item into the student ML model for processing and generating a processing result;
identifying a level of confidence of the processing result of the student ML model; and
transmitting the at least one captured data item and a request for the student ML model to be updated when the determined level of confidence is lower than a threshold confidence level.

11. The method as claimed in claim 8, wherein updating the student ML model comprises replacing a value of at least one parameter of the student ML model with a value of the received at least one updated parameter.

12. The method as claimed in claim 8, the method further comprising:
transmitting, to the teacher user device, the student ML model when sending a first request for an update to the student ML model.

13. The method as claimed in claim 8, the method further comprising:
transmitting, to the teacher user device, at least one captured data item for storing on the teacher user device.

14. A student user device for personalization of a machine learning, ML, model using a pair of user devices formed of a teacher user device and the student user device where the student user device uses the ML model for a task, the student user device comprising:
storage for storing a student machine learning, ML, model which is to be used by the student user device
at least one processor including processing circuitry; and
memory comprising one or more storage media storing instructions that, when executed by the at least one processor individually or collectively, cause the electronic device to:
transmit, to the teacher user device of the pair of user devices, at least one captured data item and a request for a student machine learning, ML, model used by the student user device to be updated;
receive, from the teacher user device, at least one updated parameter of the student ML model, the at least one updated parameter having been determined by the teacher user device; and
update, using the received at least one updated parameter, the student ML model.

15. The student user device as claimed in claim 14, the student user device further comprising a sensor for capturing the at least one captured data item.

16. The student user device as claimed in claim 15, wherein the one or more instructions, when executed by the at least one processor individually or collectively, cause the electronic device further to:
input the at least one captured data item into the student ML model for processing and generating a processing result;
identify a level of confidence of the processing result of the student ML model; and
transmit the at least one captured data item and a request for the student ML model to be updated when the determined level of confidence is lower than a threshold confidence level.

17. The student user device as claimed in claim 14, wherein the one or more instructions, when executed by the at least one processor individually or collectively, cause the electronic device further to: replace a value of at least one parameter of the student ML model with a value of the received at least one updated parameter.

18. The student user device as claimed in claim 14, wherein the one or more instructions, when executed by the at least one processor individually or collectively, cause the electronic device further to: transmit, to the teacher user device, the student ML model when sending a first request for an update to the student ML model.

19. The student user device as claimed in claim 14, wherein the one or more instructions, when executed by the at least one processor individually or collectively, cause the electronic device further to: transmit, to the teacher user device, at least one captured data item for storing on the teacher user device.
